(19) United States
(12) Patent Application Publication
(10) Pub. No.: US 2025/0260837 A1
(43) Pub. Date: Aug. 14, 2025

(54) Motion Vector Coding Using A Motion Vector Precision

(71) Applicant: Google LLC, Mountain View, CA (US)

(72) Inventors: Debargha Mukherjee, Cupertino, CA (US); Urvang Joshi, Mountain VIew, CA (US); Onur Guleryuz, San Francisco, CA (US); Yaowu Xu, Saratoga, CA (US); Yue Chen, Kirkland, WA (US); Lester Lu, Los Angeles, CA (US); Adrian Grange, Los Gatos, CA (US); Mohammed Golam Sarwer, San Jose, CA (US); Jianle Chen, San Diego, CA (US); Rachel Barker, Cambridge (GB); Chi Yo Tsai, San Francisco, CA (US)

(21) Appl. No.: 18/857,163

(22) PCT Filed: May 7, 2022
(86) PCT No.: PCT/US2022/028230

§ 371 Date: Oct. 15, 2024

(51) Int. Cl. H04N 19/523; H04N 19/105; H04N 19/139; H04N 19/176

(52) U.S. Cl. CPC H04N 19/523; H04N 19/105; H04N 19/139; H04N 19/176

(57) ABSTRACT

Motion vector (MV) coding using an MV precision is described. An MV class of a motion vector difference (MVD) is decoded. Whether to omit decoding least significant bits of offset bits of an integer portion of the MVD is determined using a MV precision. The integer portion is obtained using at least some decoded offset bits and the least significant bits of the integer portion. Whether to omit decoding least significant bits of fractional bits of a fractional portion is determined using the MV precision. The fractional portion is obtained using at least some decoded fractional bits and the least significant bits of the fractional portion. The MVD is obtained using at least the integer portion and the fractional portion. An MV for the current block is obtained using the MVD.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data using reference frames and more particularly relates to motion vector coding using a motion vector precision.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect may include a method for decoding a current block by decoding, from a compressed bitstream, a motion vector (MV) class of a motion vector difference (MVD) for the current block, where the MV class may be indicative of a set of MVDs, each MVD of the set of MVDs corresponds to respective integer portions, and where the MVD may include an integer portion and a fractional portion.

The method may include obtaining an MV precision of the MVD; determining, using the MV precision, whether to omit decoding and to set, to a predefined value, least significant bits of offset bits of the integer portion; decoding at least some of the offset bits; obtaining the integer portion using the at least some of the offset bits and the least significant bits of the integer portion; determining, using the MV precision, whether to omit decoding and to set, to the predefined value, least significant bits of fractional bits of the fractional portion; decoding the at least some of the fractional bits for the fractional portion; obtaining the fractional portion using the at least some of the fractional bits and the least significant bits of the fractional portion; obtaining the MVD using at least the integer portion and the fractional portion; obtaining a motion vector for the current block using the MVD; and obtaining a prediction block for the current block using the motion vector. Other embodiments of this aspect include corresponding computer systems, apparatus, and computer programs recorded on one or more computer storage devices, each configured to perform the actions of the methods.

Implementations may include one or more of the following features. A method where the least significant bits of the offset bits of the integer portion may constitute 2 bits in a case that the MV precision indicates a 4-integer pixel magnitude. The least significant bits of the offset bits of the integer portion may constitute 1 bit in a case that the MV precision indicates a 2-integer pixel magnitude. The least significant bits of the fractional portion may constitute the least significant bit in case that the MV precision indicates a precision that is not finer than a ¼ pixel precision. The least significant bits of the fractional portion may constitute two least significant bits in case that the MV precision indicates a precision that is not finer than a ½ pixel precision.

One general aspect may include a method for decoding a current block. The method may include decoding, from a compressed bitstream, a motion vector (MV) class of a motion vector difference (MVD) of the current block, where the MV class is indicative of a set of MVDs, and where the MVD includes an integer portion; obtaining an MV precision of the MVD; decoding, using the MV precision and the MV class, at least a subset of bits representing the integer portion of the MVD; obtaining the MVD using the bits representing the integer portion of the MVD; obtaining a motion vector for the current block using the MVD.

The method may include obtaining a prediction block for the current block using the motion vector. Other embodiments of this aspect include corresponding computer systems, apparatus, and computer programs recorded on one or more computer storage devices, each configured to perform the actions of the methods.

Implementations may include one or more of the following features. The method where decoding, using the MV precision and the MV class, the at least the subset of bits representing the integer portion of the MVD may include inferring that at least one least significant bit of bits representing the integer portion of the MVD is zero based on the MV precision.

Decoding, using the MV precision and the MV class, the at least the subset of bits representing the integer portion of the MVD may include, responsive to determining that the MV precision indicates a 4-integer pixel magnitude, inferring that two least significant bits of the bits representing the integer portion are zero.

Decoding, using the MV precision and the MV class, the at least the subset of bits representing the integer portion of the MVD may include, responsive to determining that the MV precision indicates a 2-integer pixel magnitude, inferring that one least significant bit of the bits representing the integer portion are zero.

The method may include decoding, using the MV precision, at least a subset of bits representing a fractional portion of the MVD.

Decoding, using the MV precision, the at least the subset of bits representing the fractional portion of the MVD may include responsive to determining that the MV precision may indicate a precision that is not finer than a ¼ pixel precision, inferring that a least significant bit of the bits representing the fractional portion is zero.

Decoding, using the MV precision, the at least the subset of bits representing the fractional portion of the MVD may include, responsive to determining that the MV precision indicates a precision that is not finer than a ½ pixel precision, inferring that two least significant bits of the bits representing the fractional portion are zero.

Decoding, using the MV precision, the at least the subset of bits representing the fractional portion of the MVD may include, responsive to determining that the MV precision indicates an integer pixel precision, inferring that the bits representing the fractional portion are zero.

The method may include obtaining candidate MVs for the MV; and setting respective precisions of at least some of the candidate MVs to the MV precision.

Implementations of the described techniques may include hardware, a method or process, or computer software on a computer-accessible medium.

One general aspect includes a method. The method may include obtaining a motion vector (MV) precision of a motion vector difference (MVD) of a current block. The method may include decoding, from a compressed bitstream and based on the MV precision, a subset of bits of a fractional portion of the MVD.

The method may include setting remaining bits of the fractional portion of the MVD to zero; obtaining the MVD using at least the fractional portion, obtaining a motion vector for the current block using the MVD. The method also includes obtaining a prediction block for the current block using the motion vector.

Other embodiments of this aspect include corresponding computer systems, apparatus, and computer programs recorded on one or more computer storage devices, each configured to perform the actions of the methods.

Implementations may include one or more of the following features. A method may include decoding, from the compressed bitstream, an MV class of the MVD, where the MV class is indicative of a set of MVDs, each MVD of the set of MVDs corresponds to respective integer portions; and decoding, from the compressed bitstream, an integer portion of the MVD. The method may include obtaining candidate mvs for the mv; and converting an MV precision of a candidate MV of the candidate MVs to match the MV precision.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a diagram of motion vectors representing full and sub-pixel motion.

FIG. 7 is a diagram of a sub-pixel prediction block.

FIG. 8 is a diagram of full and sub-pixel positions.

FIG. 9 is an example of a flowchart of a technique for decoding a motion vector of a current block.

FIG. 10 is a block diagram illustrating coding of MV precision for a block.

FIG. 11 illustrates frame data that may be included in a compressed bitstream.

FIG. 12 is an example of a flowchart of a technique for decoding a motion vector of a current block.

FIG. 13 is an example of a flowchart of a technique for encoding a motion vector of a current block.

FIG. 14 is another example of a flowchart of a technique for decoding a motion vector for a current block.

FIG. 15 is another example of a flowchart of a technique for decoding a motion vector for a current block.

### DETAILED DESCRIPTION

As mentioned, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between the previously coded pixel values, or between a combination of previously coded pixel values, and those in the current block.

Encoding using spatial similarities is known as intra prediction. Intra prediction can attempt to predict the pixel values of a block of a frame of a video stream using pixels peripheral to the block; that is, using pixels that are in the same frame as the block but that are outside the block. Intra prediction can be performed along a direction of prediction where each direction can correspond to an intra prediction mode. The intra prediction mode can be signaled by an encoder to a decoder.

Encoding using temporal similarities is known as inter prediction or motion-compensated prediction (MCP). A prediction block of a current block (i.e., a block being coded) is generated by finding a corresponding block in a reference frame following a motion vector (MV). That is, inter prediction attempts to predict the pixel values of a block using a possibly displaced block or blocks from a temporally nearby frame (i.e., a reference frame) or frames. A temporally nearby frame is a frame that appears earlier or later in time in the video stream than the frame (i.e., the current frame) of the block being encoded (i.e., the current block). A motion vector used to generate a prediction block refers to (e.g., points to or is used in conjunction with) a frame (i.e., a reference frame) other than the current frame. A motion vector may be defined to represent a block or pixel offset between the reference frame and the corresponding block or pixels of the current frame.

The motion vector(s) for a current block in motion-compensated prediction may be encoded into, and decoded from, a compressed bitstream. A motion vector for a current block (i.e., a block being encoded) is described with respect to a co-located block in a reference frame. The motion vector describes an offset (i.e., a displacement) in the horizontal direction (i.e., MVx) and a displacement in the vertical direction (i.e., MVy) from the co-located block in the reference frame. As such, an MV can be characterized as a 3-tuple (f, MVx, MVy) where f is indicative of (e.g., is an index of) a reference frame, MVx is the offset in the horizontal direction from a collocated position of the reference frame, and MVy is the offset in the vertical direction from the collocated position of the reference frame. As such, at least the offsets MVx and MVy are written (i.e., encoded) into the compressed bitstream and read (i.e., decoded) from the encoded bitstream.

To lower the rate cost of encoding the motion vectors, a motion vector may be encoded differentially. Namely, a predicted motion vector (PMV) is selected as a reference motion vector, and only a difference between the motion vector (MV) and the reference motion vector (also called the motion vector difference (MVD)) is encoded into the bitstream. The reference (or predicted) motion vector may be a motion vector of one of the neighboring blocks, for example. Thus, MVD=MV-PMV. The neighboring blocks can include spatial neighboring blocks (i.e., blocks in the same current frame as the current block). The neighboring blocks can include temporal neighboring blocks (i.e., blocks in frames other than the current frame). An encoder codes MVD in the compressed bitstream; and a decoder decodes the MVD from the compressed bitstream and adds it to prediction motion vector (PMV) to obtain the motion vector (MV) of a current block.

In some situations, the prediction block that results in the best (e.g., smallest) residual may not correspond with pixels in the reference frame. That is, the best motion vector may point to a location that is between pixels of blocks in the reference frame. In this case, motion compensated prediction at the sub-pixel level is useful.

MCP may involve the use of a sub-pixel interpolation filter that generates filtered sub-pixel values at defined locations between the full pixels (also called integer pixels) along rows, columns, or both. The interpolation filter may be one of a number of interpolation filters available for use in motion compensated prediction. Sub-pixel interpolation is further described below.

Different interpolation filters may be available. Each of the interpolation filters may be designed to provide a different frequency response. In an example, the available interpolation filters may include a smooth filter, a normal filter, a sharp filter, and a bilinear filter. The interpolation filter to be used by a decoder to generate a prediction block may be signaled in the header of the frame containing the block to be predicted. As such, the same interpolation filter is used to generate sub-pixel prediction blocks for all blocks of the frame. The interpolation filter may be signaled at a coding unit level. As such, the same interpolation filter is used for every sub-block (e.g., every prediction block) of the coding unit to generate sub-pixel prediction blocks for the sub-blocks of the coding unit.

An encoder may generate a prediction block based on each of the available interpolation filters. The encoder then selects (i.e., to signal to the decoder) the filter that results in, e.g., the best rate-distortion ratio. A rate-distortion ratio refers to a ratio that balances an amount of distortion (i.e., loss in video quality) with rate (i.e., the number of bits) required for encoding. A coding unit (sometimes called a super-block or a macro-block) may have a size of 128×128 pixels, 64×64 pixels, or some other size, and can be recursively decomposed all the way down to blocks having sizes as small as, in an example, 4×4 pixels.

Coding an MV as used herein refers to the coding of the motion vector itself and to coding of an MVD of the motion vector. In either case, coding an MV includes coding the horizontal offset (i.e., MVx) and coding the vertical offset (i.e., MVy) of the motion vector or the coding the horizontal offset (i.e., MVDx) and coding the vertical offset (i.e., MVDy) of the motion vector difference. When implemented by an encoder, “coding” means encoding in a compressed bitstream. When implemented by a decoder, “coding” means decoding from an compressed bitstream.

Coding the motion vector can include entropy coding the horizontal offset and the vertical offsets. As such, a context is determined for the motion vector and a probability model, corresponding to the context, is used for the coding the motion vector. Entropy coding is a technique for “lossless” coding that relies upon probability models that model the distribution of values occurring in an encoded video bitstream. By using probability models based on a measured or estimated distribution of values, entropy coding can reduce the number of bits required to represent video data close to a theoretical minimum. In practice, the actual reduction in the number of bits required to represent video data can be a function of the accuracy of the probability model, the number of bits over which the coding is performed, and the computational accuracy of fixed-point arithmetic used to perform the coding.

Several inter-prediction modes may be available. For example, one available inter-prediction mode represents that the motion vector of a block is 0. This may be referred to as a ZEROMV mode. Another inter-prediction mode may represent that the motion vector of the block is the reference motion vector. This may be referred to as a REFMV mode. When the motion vector for the block is not zero, and is different from the reference motion vector, the motion vector may be encoded using a reference motion vector. This mode may be referred to as a NEWMV mode. When the inter-prediction mode is NEWMV, then an MVD may be coded for the MV. Other inter-prediction modes may be available.

As mentioned above, filters having different frequency responses can be used to generate a motion vector at sub-pixel positions. Accordingly, and due to the use of these filters, reference blocks at different sub-pixel positions may have different characteristics in the transform domain. For example, a reference block at a sub-pixel position generated by a low-pass filter is likely to have lower energy in a high frequency band than a reference block at a full-pixel position. Since a residual block is the difference between a source block and a reference block, the energy distribution in the residual block is thus correlated with that of a reference block. As also mentioned above, the efficiency of entropy coding can be directly related to the probability model, which is in turn selected based on the context model.

As alluded to, motion vectors may be coded to (e.g., using) a particular resolution or motion vector precision (MV precision). For example, certain (older) codecs may only support integer precision; H.264 and H.265 codecs support motion vectors having ¼ precision; and AV1 supports motion vector precision at either ¼ or ⅛th MV precision.

A conventional codec may include a frame-level syntax element that indicates the MV precision of motion vectors (including precisions of MVDs) of inter-predicted blocks of the frame. In an example, a frame-level flag may indicate whether motion vectors of blocks of the frame are coded using ¼ or ⅛ MV precision. Either way, the MV precision is at the given frame.

However, frame-level MV precision may not capture local (e.g., super-block level or block level) motion characteristics. A video frame may contain mixed motion where one part of the frame (e.g., the frame background) has no motion and another part (e.g., the frame foreground) has very high motion. As such, coding all motion vectors of a frame at a given MV precision can reduce the compression efficiency because more bits than otherwise necessary would be used.

For example, coding every motion vector of a frame to ⅛ MV precision may use a large number of coding bits, which may outweigh the benefits of ⅛ MV precision for at least some of the motion vectors of the frame. That is, the bitrate required to code a motion vector (or MVD) at a higher MV precision (e.g., ⅛ MV precision) may outweigh any distortion gains as compared to coding at a lower MV precision (e.g., ½ or even integer MV precision). For some types of video content (e.g., blocks within a frame), it may be sufficient to only use integer-pixel MV precision and to not code motion using interpolation.

Implementations according to this disclosure use flexible signaling (coding) of MV precisions to improve the coding efficiency and to reduce the number of bits required to code MVs including the coding of MVDs. The MV precision can be coded at a block level and/or at a group-of-blocks level. The group-of-blocks can be a group of frames, a frame, a super-block, or some other group of blocks. As such, MV precision coding can be hierarchical where the MV precision coded at a higher level (e.g., frame or super-block) can be used to limit the possible MV precision values at a lower level (e.g., super-block or block). The lowest level of the hierarchy is a current block (i.e., the block being predicted or coded).

An MV precision of a lower level (e.g., block) is said to be within or “limited by” a higher level (e.g., super-block) MV precision. As further described herein, the upper level MV precision may be a maximum MV precision. That a lower level MV precision is “limited by” the upper level MV precision means that the lower level MV precision is less than or equal to the upper level MV precision. To illustrate, the motion vectors of any sub-block of a super-block cannot have an MV precision that exceeds a maximum MV precision set of the super-block. Similarly, the upper level MV precision may be a minimum MV precision. That a lower level MV precision is “limited by” the upper level MV precision means that the lower level MV precision is greater than or equal to the upper level MV precision. To illustrate, the motion vectors of any sub-block of a frame cannot have an MV precision that is less than a minimum MV precision set of the frame.

To illustrate, conventionally, a motion vector may be encoded using first bits that indicate an integer (or magnitude) portion of the motion vector and second bits that indicate a fractional portion (i.e., the sub-pixel precision). In an example, a motion vector may be coded using 12 bits, where the 9 most significant bits (MSBs) indicate the integer portion and the 3 least significant bits (LSBs) indicate the fractional portion up to ⅛ MV precision. The first LSB indicates whether the precision is either ⅛ or not. If the value of first LSB is equal to 1, the precision is ⅛; otherwise the precision is not equal to ⅛. When the precision is not equal to ⅛ (i.e., the first LSB is equal to 0), then the second LSB indicates whether the precision is ¼ or not. If the first LSB is equal to 0 and the second LSB is equal to 1, then the precision is ¼. If the first LSB is 0 and the second LSB is 0, then the precision can be either integer or ½. If both of the first and second LSBs are 0, then the third LSB indicates whether the precision is ½ or integer. Thus, 000, 001, 010, 011, 100, 101, 110, 111 may indicate, respectively, integer, ⅛, ¼, ⅛, ½, ⅛, ¼, and ⅛ precision for a particular motion vector.

If, for example, motion vectors of 30 blocks of a frame require integer precision, then the coded motion vectors of these blocks would include a total of 90 (30*3) 0 bits. However, using flexible MV precision, as described herein, roughly the 90 bits (in fact, less than all of the 60 bits as becomes apparent later on) may be saved if the headers of these blocks (or super-blocks or a frame that include these blocks) indicate (e.g., include syntax elements indicating) that the blocks are coded using integer precision. The bits can be saved because the decoder can infer that these bits are 0 based on a coded MV precision.

Similarly, assume that a frame header includes an MV precision indicating that blocks of the frame may be coded using up to a ½ precision. Thus, the blocks of this frame can only be coded using integer or ½ MV precisions. As such, it would be unnecessary to use 2 LSBs to code the MV precisions. One LSB bit would be sufficient therewith saving roughly 30 (30*1=30) bits. The other bit can be inferred to be zero based on the MV precision.

To reduce the number of bits required for coding MVs (or corresponding MVDs), some codecs may code a class and an offset value within the class. The class can be indicative of the magnitude of the MVD. Flexible motion vector precision can be used to reduce the number of bits required to code the offset. As further described below, the MV precision of a block can limit the possible values that the offset can take. Thus, by identifying that certain offsets are not possible given the MV precision, the number of bits required to code the offset can be reduced and the uncoded bits can be inferred. Similarly, the MV precision can limit the possible values that the fractional precision can take. Thus, by identifying that certain precision values are not possible given the MV precision, the number of bits required to code the fractional part can be reduced and the uncoded bits can be inferred.

Further details of motion vector coding using a motion vector precision are described herein with initial reference to a system in which it can be implemented.

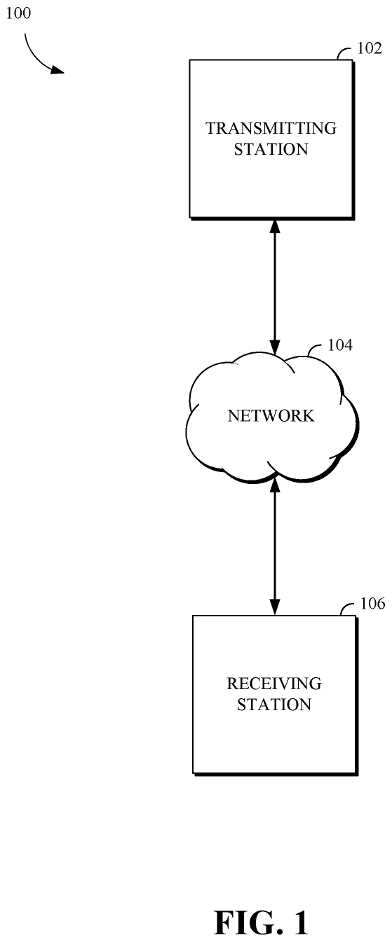

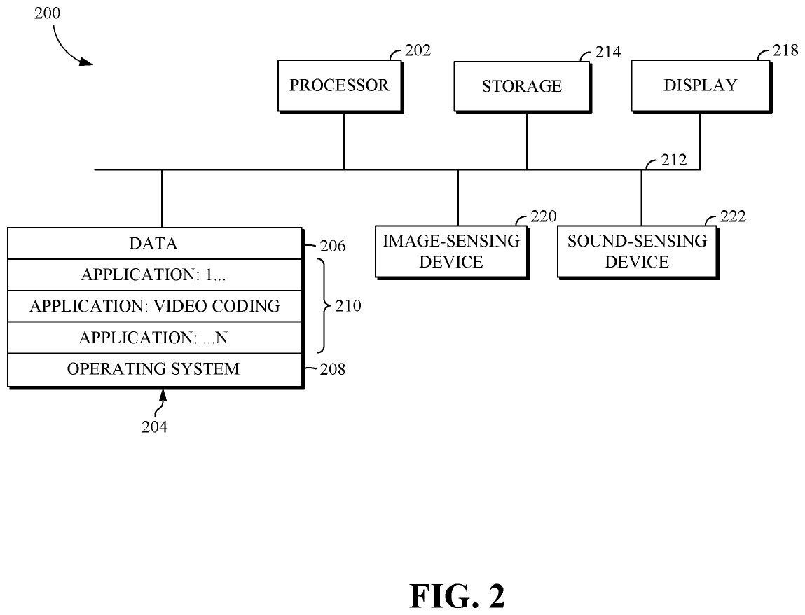

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

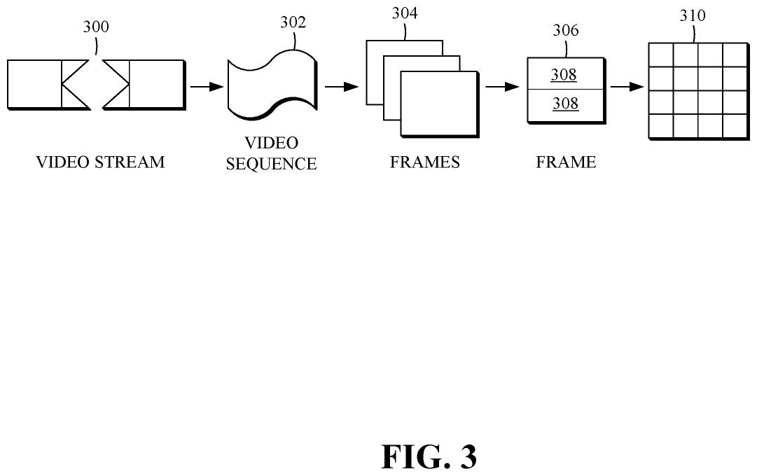

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

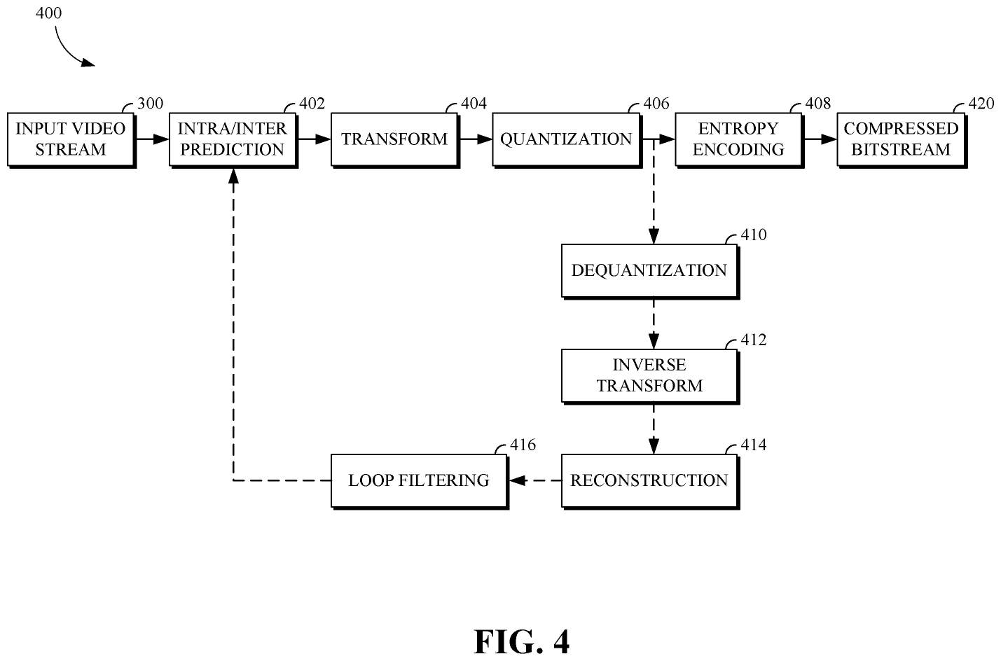

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

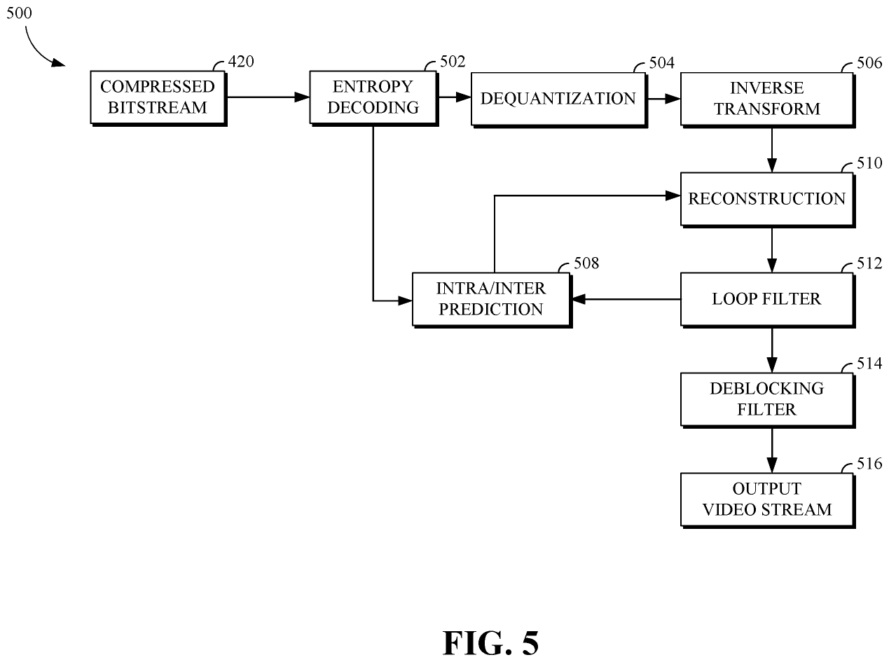

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the deblocking filtering stage 514.

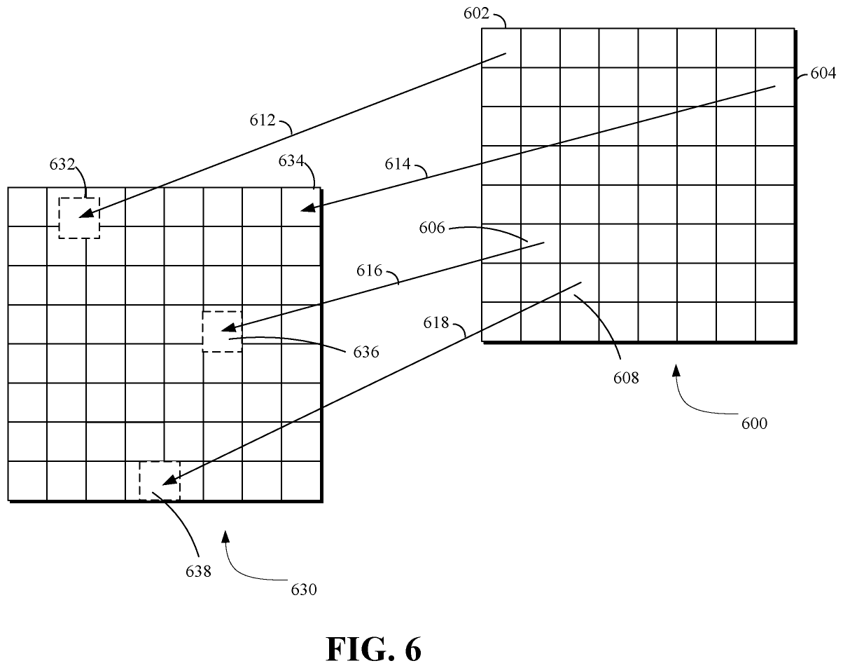

FIG. 6 is a diagram of motion vectors representing full and sub-pixel motion. In FIG. 6, several blocks 602, 604, 606, 608 of a current frame 600 are inter predicted using pixels from a reference frame 630. In this example, the reference frame 630 is a reference frame, also called the temporally adjacent frame, in a video sequence including the current frame 600, such as the video stream 300. The reference frame 630 is a reconstructed frame (i.e., one that has been encoded and decoded such as by the reconstruction path of FIG. 4) that has been stored in a so-called last reference frame buffer and is available for coding blocks of the current frame 600. Other (e.g., reconstructed) frames, or portions of such frames may also be available for inter prediction. Other available reference frames may include a golden frame, which is another frame of the video sequence that may be selected (e.g., periodically) according to any number of techniques, and a constructed reference frame, which is a frame that is constructed from one or more other frames of the video sequence but is not shown as part of the decoded output, such as the output video stream 516 of FIG. 5.

A prediction block 632 for encoding the block 602 corresponds to a motion vector 612. A prediction block 634 for encoding the block 604 corresponds to a motion vector 614. A prediction block 636 for encoding the block 606 corresponds to a motion vector 616. Finally, a prediction block 638 for encoding the block 608 corresponds to a motion vector 618. Each of the blocks 602, 604, 606, 608 is inter predicted using a single motion vector and hence a single reference frame in this example, but the teachings herein also apply to inter prediction using more than one motion vector (such as bi-prediction and/or compound prediction using two different reference frames), where pixels from each prediction are combined in some manner to form a prediction block.

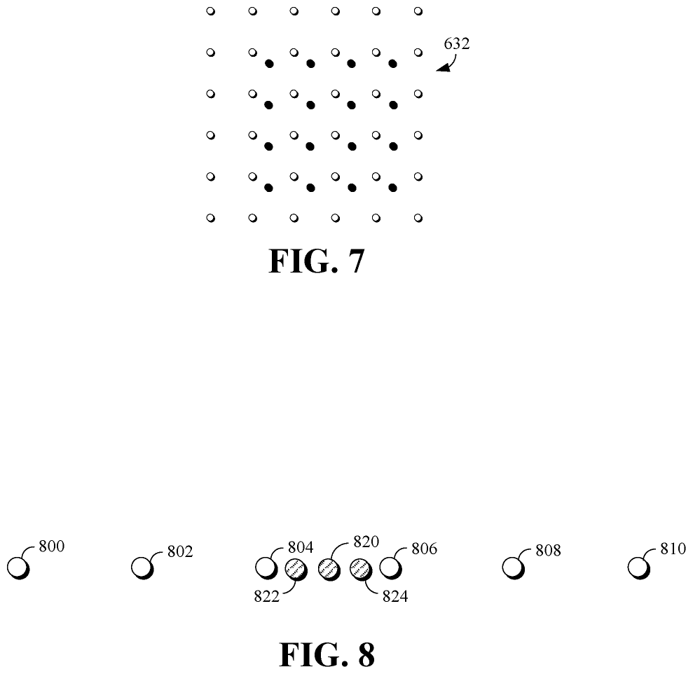

FIG. 7 is a diagram of a sub-pixel prediction block. FIG. 7 includes the block 632 and neighboring pixels of the block 632 of the reference frame 630 of FIG. 6. Integer pixels within the reference frame 630 are shown as unfilled circles. The integer pixels, in this example, represent reconstructed pixel values of the reference frame 630. The integer pixels are arranged in an array along x- and y-axes. Pixels forming the prediction block 632 are shown as filled circles. The prediction block 632 results from sub-pixel motion along two axes.

Generating the prediction block 632 can require two interpolation operations. In some cases, generating a prediction block can require only one interpolation operation along one of x and y axes. A first interpolation operation to generate intermediate pixels followed by a second interpolation operation to generate the pixels of the prediction block from the intermediate pixels. The first and the second interpolation operations can be along the horizontal direction (i.e., along the x axis) and the vertical direction (i.e., along the y axis), respectively. Alternatively, the first and the second interpolation operations can be along the vertical direction (i.e., along the y axis) and the horizontal direction (i.e., along the x axis), respectively. The first and second interpolation operations can use a same interpolation filter type. Alternatively, the first and second interpolation operations can use different interpolation filter types.

In order to produce pixel values for the sub-pixels of the prediction block 632, an interpolation process may be used. In one example, the interpolation process is performed using interpolation filters such as finite impulse response (FIR) filters. An interpolation filter may comprise a 6-tap filter, an 8-tap filter, or other number of taps. The taps of an interpolation filter weight spatially neighboring pixels (integer or sub-pel pixels) with coefficient values to generate a sub-pixel value. In general, the interpolation filters used to generate each sub-pixel value at different sub-pixel positions (e.g., ½, ¼, ⅛, 1/16 or other sub-pixel positions) between two pixels are different (i.e., have different coefficient values).

FIG. 8 is a diagram of full and sub-pixel positions. In the example of FIG. 8, a 6-tap filter is used. This means that values for the sub-pixels or pixel positions 820, 822, 824 can be interpolated by applying an interpolation filter to the pixels 800-810. Only sub-pixel positions between the two pixels 804 and 806 are shown in FIG. 8. However, sub-pixel values between the other full pixels of the line of pixels can be determined in a like manner. For example, a sub-pixel value between the two pixels 806 and 808 may be determined or generated by applying an interpolation filter to the pixels 802, 804, 806, 808, 810, and an integer pixel adjacent to the pixel 810, if available.

Using different coefficient values in an interpolation filter, regardless of its size, results in different characteristics of filtering and hence different compression performance. In some implementations, the set of interpolation filters may be designed for 1/16-pixel precision and include at least two of a Bi-linear filter, an 8-tap filter (EIGHTTAP), a sharp 8-tap filter (EIGHTTAP_SHARP), or a smooth 8-tap filter (EIGHTTAP_SMOOTH). Each interpolation filter has a different frequency response.

As further described below, an MV precision may be encoded for a group of blocks and/or a block (e.g., a prediction block). In an example, the MV precision may be encoded in a header of the group of blocks or a header of a block. The group of blocks can be a group of frames, a frame, segment of blocks, a tile of blocks, or a super-block. More generally, the group of blocks can be any structure that is used for packetizing data and that provides identifying information for the contained data. In AV1 vernacular, such structure is referred to as an Open Bitstream Units (OBU).

An encoder and a decoder may support the same set of allowed MV precisions. The set of allowed MV precisions can be an ordered set. The set of allowed MV precisions can be implemented (or represented) using any suitable data structure. In an example, the data structure can be an enumeration given by

```
enum {
      MV_PRECISION_4_PEL = 0,
      MV_PRECISION_2_PEL = 1,
      MV_PRECISION_1_PEL = 2,
      MV_PRECISION_HALF_PEL = 3,
      MV_PRECISION_QTR_PEL = 4,
      MV_PRECISION_EIGHTH_PEL = 5,
      NUM_MV_PRECISIONS,
};
```

In the enumeration, MV_PRECISION_4_PEL, MV_PRECISION_2_PEL, MV_PRECISION_1_PEL, MV_PRECISION_HALF_PEL, MV_PRECISION_QTR_PEL, and MV_PRECISION_EIGHTH_PEL define constants, each having the corresponding value (e.g., the constant MV_PRECISION_1_PEL has the integer value 2). The constant NUM_MV_PRECISIONS is the number of allowed MV precisions in the set. While described herein a set of allowed MV precisions that includes six (6) MV precisions, more or fewer MV precisions are possible. For example, the set of allowed MV precisions may include an MV precision MV_PRECISION_SIXTEENTH_PEL corresponding to 1/16th fractional pixel precision. In another example, the set of allowed MV precisions may also include MV precision MV_PRECISION_8_PEL corresponding to 8-pel precision. For example, the set of allowed MV precisions may not include the MV precision MV_PRECISION_EIGHTH_PEL.

That the set allowed MV precisions is ordered means that two MV precisions of the set can be compared to determine which is smaller or larger or whether the MV precisions are equal. References to an “MV precision” should be understood from the context to mean one of the MV precision values from the set of allowed MV precisions.

The MV precision MV_PRECISION_EIGHTH_PEL indicates ⅛ MV precision. The MV precision MV_PRECISION_QTR_PEL indicates ¼ MV precision. The MV precision MV_PRECISION_HALF_PEL indicates ½ MV precision. The MV precisions MV_PRECISION_1_PEL=2, MV_PRECISION_2_PEL=1, and MV_PRECISION_4_PEL indicate magnitudes of motion vectors in integer precisions. MV magnitudes are multiples of 2 when the MV precision is MV_PRECISION_2_PEL, and multiples of 4 when the MV precision is MV_PRECISION_4_PEL. For example, if the MV precision of a block is MV_PRECISION_2_PEL, then the supported motion vectors are 0, 2, 4, 6, 8, and so on. Similarly, if the MV precision is equal to MV_PRECISION_4_PEL, then the value of motion vectors are multiple of 4, for example, 0, 4, 8, 12, 16, and so on.

In an example, the MV precision list can be dynamically created before starting the decoding of a current block (i.e., the current prediction block), before starting the decoding of the current super-block that includes the current block, before starting the decoding of the current frame that includes the super-block, or before starting the decoding of any group of blocks. In an example, a dynamic precision list (DPL) can be generated based on previously decoded MV precisions. The previously decoded MV precisions are MV precisions of previously decoded neighboring blocks. In an example, the list of MV precisions that the decoder is to use with (for) a group of blocks can be transmitted in the compressed bitstream. For example, the encoder may transmit the MV precisions that the decoder is to use. To illustrate, the encoder may encode, for a group of blocks, MV_PRECISION_4_PEL and MV_PRECISION_EIGHTH_PEL in the compressed bitstream. As such, all motion vectors of blocks of the group of blocks must have one of the MV precisions MV_PRECISION_4_PEL or MV_PRECISION_EIGHTH_PEL.

An MV precision encoded for a block indicates the MV precision of the MV of the block (or equivalently, the MV precision of an MVD of the MV). An MV precision encoded for a group of blocks may be or may indicate a limit on the MV precisions of the MVDs of the blocks of the group of blocks. That is, none of the motion vectors of the blocks of the group of blocks can have an MV precision that violates (e.g., is not within) the limit. The limit can include a maximum MV prevision or a minimum MV precision. One of more syntax elements (e.g., flags) may be encoded in a bitstream, such as the compressed bitstream 420 of FIG. 5, to indicate whether the limit is a maximum or a minimum. In an example, both, a maximum MV precision and a minimum MV precision may be encoded for a group of blocks.

To illustrate, assume that MV_PRECISION_HALF_PEL is encoded as a maximum MV precision for a super-block. As such, no sub-block of the super-block can have an MV precision that violates (i.e., exceeds) MV_PRECISION_HALF_PEL. Thus, no sub-block of the super-block can have any of the MV precisions MV_PRECISION_QTR_PEL or MV_PRECISION_EIGHTH_PEL. As another illustration, assume that MV_PRECISION_1_PEL is encoded as a minimum MV precision for a frame. As such, no block of the group of blocks can be one of the MV precisions MV_PRECISION_2_PEL or MV_PRECISION_4_PEL. As yet another illustration, the maximum MV precision for a frame may be MV_PRECISION_QTR_PEL and the minimum MV precision for a super-block of the frame may be MV_PRECISION_1_PEL. As such, the motion vectors of the sub-blocks of super-block can have only one of the MV precisions MV_PRECISION_1_PEL, MV_PRECISION_HALF_PEL, or MV_PRECISION_QTR_PEL.

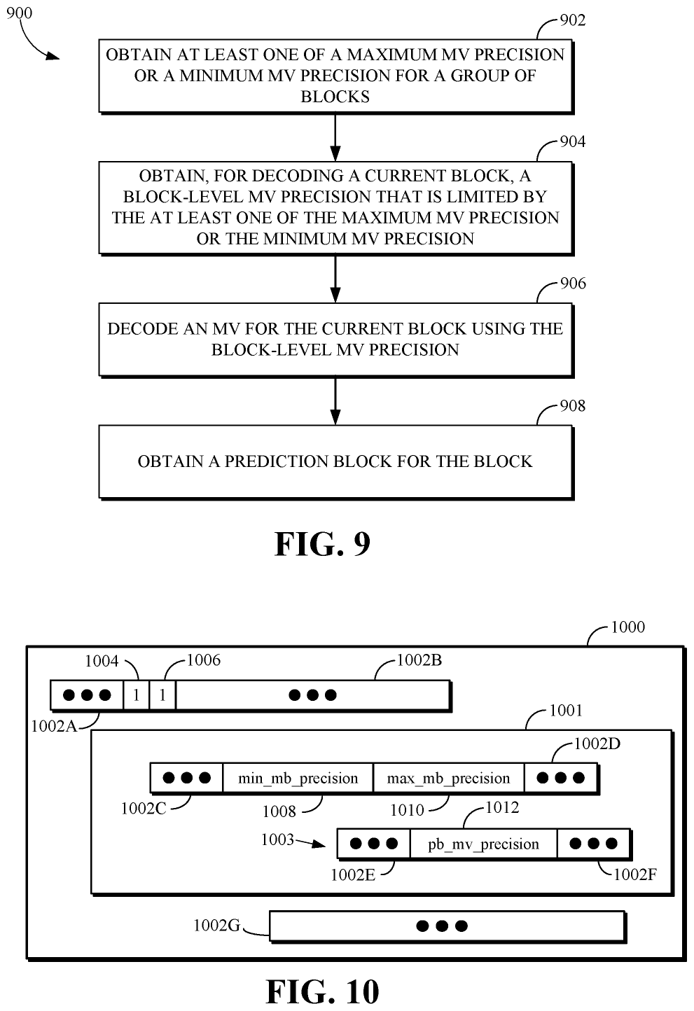

FIG. 9 is an example of a flowchart of a technique 900 for decoding a motion vector of a current block. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 900. The technique 900 may be implemented in whole or in part in the intra/inter prediction stage 508 of the decoder 500 of FIG. 5. The technique 900 can be implemented using specialized hardware or firmware. Multiple processors, memories, or both, may be used.

At 902, at least one of a maximum MV precision or a minimum MV precision may be obtained for a group of blocks. In an example, the at least one of the maximum MV precision or the minimum MV precision may be decoded from a compressed bitstream, such as the compressed bitstream 420 of FIG. 5. In an example, the maximum MV precision may be inferred based on other syntax elements. In an example, the minimum MV precision may be inferred based on other syntax elements. As mentioned above, the group of blocks can be a super-block, a frame, a segment, a tile, a super-block, or some other entity, object, data structure, or the like that the decoder processes as a group of blocks or that the decoder processes blocks therein.

At 904, a block-level MV precision for decoding the current block is obtained. The block-level MV precision is limited by the maximum MV precision or the minimum MV precision. That is, the block-level MV precision has to be less than or equal to the maximum MV precision in the case that the maximum MV precision is obtained at 902; has to be greater than or equal to the minimum MV precision in the case that the minimum MV precision is obtained at 902; or both in the case that both of the maximum MV precision and the minimum MV precision are obtained at 902.

To illustrate, assume that the group of blocks is a super-block. The maximum MV precision of the super-block may be denoted max_mb_precision, the minimum MV precision of the super-block may be denoted min_mb_precision, and a block-level MV precision may be denoted pb_mv_precision. To be clear, pb_mv_precision denotes the precision of the MVD (or, equivalently, of the MV) of a predicted block (i.e., a current block to be predicted). In an example, the block-level MV precision can be signaled at a super-block level or a prediction block-level for a sub-block of the super-block. The header of a frame (or the super-block itself) can include syntax elements (e.g., flags) indicating whether any of a maximum MV precision or a minimum MV precision is signaled at the super-block level.

FIG. 10 is a block diagram illustrating coding of MV precision for a block. FIG. 10 illustrates frame data 1000 that may be included in a compressed bitstream. The frame data 1000 may include super-block data, such as super-block data 1001. The frame data 1000 may include other data 1002A-1002G that may not be pertinent to the description of coding of MV precision.

A header of the frame may include a first flag 1004 and a second flag 1006. The first flag 1004 may indicate whether super-block data (e.g., headers of super-blocks of the frame) of the frame data 1000 include respective syntax elements min_mb_precision. If the first flag 1004 has a certain value (e.g., 1, as illustrated), then the super-block data include the respective syntax elements min_mb_precision; otherwise, the super-block data would not include the respective syntax elements min_mb_precision. Similarly, the second flag 1006 may indicate whether the super-block data include respective syntax elements max_mb_precision. If the second flag 1006 has the certain value (e.g., 1, as illustrated), then the super-block data include the respective syntax elements max_mb_precision; otherwise, the super-block data would not include the respective syntax elements max_mb_precision. In some examples, only one of the first flag or the second flag may be included the frame data 1000.

As the first flag is illustrated as being equal to the certain value (e.g., 1), then the super-block data 1001 includes the syntax element min_mb_precision (i.e., a syntax element 1008); and as the second flag is illustrated as being equal to the certain value (e.g., 1), then the super-block data 1001 includes the syntax element max_mb_precision (i.e., a syntax element 1010). For a specific block of the super-block, the block data can include a syntax element 1012 (i.e., pb_mv_precision) that indicates the precision of the motion vector of the block. The MV precision of the block is limited by the maximum MV precision max_mb_precision and/or minimum MV precision min_mb_precision, whichever is included in the super-block data. That is, min_mb_precision≤pb_mv_precision≤max_mb_precision.

In the case that only max_mb_precision is included and max_mb_precision is equal to the smallest possible MV precision value (e.g., MV_PRECISION_4_PEL), then block data 1003 may not include an MV precision for the block since pb_mv_precision can be inferred to be equal to max_mb_precision. Similarly, in the case that only min_mb_precision is included and min_mb_precision is equal to the largest possible MV precision value (e.g., MV_PRECISION_EIGHTH_PEL), then the block data 1003 may not include an MV precision for the block since pb_mv_precision can be inferred to be equal to min_mb_precision.

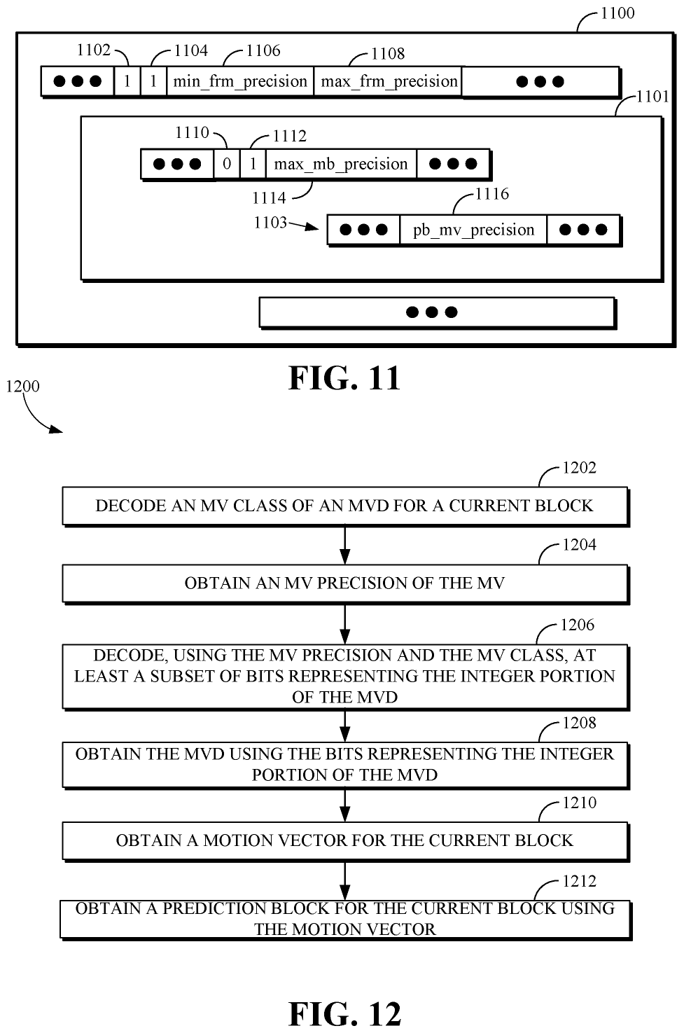

While not specifically shown in FIG. 10 and as described above, the frame data 1000 can include a frame-level maximum MV precision for the frame (e.g., max_frm_precision), a frame-level minimum MV precision (e.g., min_frm_precision). FIG. 11 is a block diagram illustrating another example of MV precision coding for a block. FIG. 11 illustrates frame data 1100 that may be included in a compressed bitstream. The frame data 1100 may include super-block data, such as super-block data 1101. The super-block data may include block data, such as block data 1103. The frame data 1100 may include other data illustrated with ellipsis-filled boxes and which may not be pertinent to the description of coding of MV precision.

The frame data 1100 includes a first flag 1102 that indicates whether the frame data 1100 includes min_frm_precision and a second flag 1104 that indicates whether the frame data 1100 includes max_frm_precision. The first flag 1102 and the second flag 1104 are illustrated as having a value (i.e., 1) indicating that the frame data 1100 includes the syntax elements min_frm_precision (i.e., a syntax element 1106) and max_frm_precision (i.e., a syntax element 1108). A flag 1110 of the super-block data 1101 and having a value of zero, illustrates that the super-block data 1101 does not include a syntax element similar to the syntax element 1008 of FIG. 10. As such, the min_mb_precision value for this super-block can be assumed to be (e.g., inferred to be, set to, etc.) the value of min_frm_precision. A flag 1112 of the super-block data 1101 and having a value of one, illustrates that the super-block data 1101 includes a maximum MV precision max_mb_precision. As such, the super-block data 1101 includes a syntax element 1114 for the max_mb_precision. For a specific block of the super-block, the block data can include a syntax element 1116 (i.e., pb_mv_precision) that indicates the precision of the motion vector of the block.

As can be appreciated from the foregoing, other arrangements of syntax elements and flags are possible.

In an example, the block-level maximum MV precision may be inferred based on the size of the block. For example, small blocks (e.g., 4×4 or 8×8), which may be characterized by or associated with high level of motion, may be associated with motion vectors having large magnitudes but lower precision. MV precisions of motion vectors of such blocks may not be larger than a threshold maximum MV precision. The threshold maximum MV precision may be MV_PRECISION_HALF_PEL or some other MV precision. More generally, if the size of a coding block is smaller than or equal to a minimum threshold block size, then the MV precision can be inferred to be a particular MV precision.

Similarly, large blocks (e.g., 64×64 or 128×128), which may be characterized by or associated with slow motion, may be associated with motion vectors having small magnitudes but higher precision. MV precisions of motion vectors of such blocks may not be smaller than a threshold minimum MV precision. The threshold minimum MV may be MV_PRECISION_QTR_PEL or some other MV precision. More generally, if the size of a coding block is greater than or equal to a maximum threshold block size, then the MV precision can be inferred to be a particular MV precision.

In an example, at least one of the maximum MV precision (max_mb_precision) or the minimum MV precision (min_mb_precision) may be inferred based on the inter-prediction mode of the block. For example, a compound inter-prediction that uses 2 new motion vectors may be associated with motion vectors having higher precision. In this context, compound prediction refers to obtaining and combining two prediction blocks using 2 different MVs to obtain prediction block. Each of the MVs can be as described with respect to NEWMV above. MV precisions of motion vectors of such compound-predicted blocks may not be smaller than a threshold minimum MV precision, which may be the same or different from the threshold minimum MV precision described above. Other associations between inter-prediction modes and threshold minimum MV precisions or threshold maximum MV precisions are possible.

According to the foregoing, the precision of the motion vector of a predicted block, pb_mv_precision, can be coded using entropy coding. In an example, one symbol can be used to code pb_mv_precision. A context is determined for coding the syntax element (i.e., symbol) pb_mv_precision and a probability model, corresponding to the context, is used for the pb_mv_precision.

As is known, entropy coding is a technique for “lossless” coding that relies upon probability models that model the distribution of values occurring in an encoded video bitstream. By using probability models based on a measured or estimated distribution of values, entropy coding can reduce the number of bits required to represent video data close to a theoretical minimum. In practice, the actual reduction in the number of bits required to represent video data can be a function of the accuracy of the probability model, the number of bits over which the coding is performed, and the computational accuracy of fixed-point arithmetic used to perform the coding. A purpose of context modeling is to obtain probability distributions for a subsequent entropy coding engine, such as arithmetic coding, Huffman coding, and other variable-length-to-variable-length coding engines. To achieve good compression performance, a large number of contexts may be required. For example, some video coding systems can include hundreds or even thousands of contexts for transform coefficient coding alone. Each context can correspond to a probability distribution.

In an example, the context of the entropy symbol can be derived using at least one of the maximum and/or minimum allowed MV precisions of the hierarchy that includes the block. For example, the context can be derived using, if available, at least one max_mb_precision or min_mb_precision. For example, the context can be derived using, additionally or alternatively, and if available, at least one of max_frm_precision or min_frm_precision. The context can additionally be derived using MV precisions of neighboring blocks of the block. The neighboring blocks can include spatially neighboring blocks. The spatially neighboring blocks can be or include the above and left neighboring blocks. However, other neighboring blocks are possible. As such, in an example, the context of the entropy symbol can be derived from the maximum allowed MV precision of the block and MV precisions of neighboring blocks (e.g., the top and left neighboring blocks).

In an example, a flag (denoted pb_mv_precision_same_as_max_precision_flag) can be signaled by the encoder and decoded by the decoder to indicate whether pb_mv_precision is the same as max_mb_precision or not. If pb_mv_precision_same_as_max_precision_flag has a value of 1, the value of pb_mv_precision can be set to the same value as max_mv_precision. If the value of pb_mv_precision_same_as_max_precision_flag is equal to 0, an additional symbol can be signaled (i.e., encoded by an encoder and decoded by a decoder) to indicate the MV precision value. The additional symbol can be the difference between the max_mb_precision-1 value and the pb_mb_precision value. Table I illustrates a pseudocode for the differential coding of pb_mv_precision when pb_mv_precision_same_as_max_precision_flag is used.

TABLE I

```
decode pb_mv_precision_same_as_max_precision_flag
If (pb_mv_precision_same_as_max_precision_flag == 0) {
      decode remaining_precision
      pb_mv_precision = max_mv_precision −1 +
      remaining_precision
} else
      pb_mv_precision = max_mv_precision
```

In an example, a flag (denoted pb_mv_precision_same_as_min_precision_flag) can be signaled by an encoder and decoded by a decoder to indicate whether pb_mv_precision is the same as min_mb_precision or not. Table II illustrates a pseudocode for the differential coding of the pb_mv_precision when pb_mv_precision_same_as_min precision_flag is used.

TABLE II

```
decode pb_mv_precision_same_as_min_precision_flag
If (pb_mv_precision_same_as_min_precision_flag == 0) {
      decode remaining_precision
      pb_mv_precision = min_mv_precision + 1 +
      remaining_precision
} else
      pb_mv_precision = min_mv_precision
```

In another example, the MV precision of a block can be predicted from the MV precisions of neighboring blocks. For example, a predicted MV precision, pred_mv_precision, can be set equal to the largest (or smallest) of the MV precisions of top and left (or other) neighboring blocks. For a predicted block, a flag (pb_mv_precision_same_as_pred_mv_precision_flag) can be signaled to indicate whether pb_mv_precision is the same as the pred_mv_precision or not. Table III illustrates a pseudocode for the differential coding of the pb_mv_precision when pb_mv_precision_same_as_pred_mv_precision_flag is used.

TABLE III

```
pred_mv_precision = max(top_mv_precision, left_mv_precision)
decode pb_mv_precision_same_as_pred_mv_precision_flag
If (pb_mv_precision_same_as_pred_mv_precision_flag == 0) {
      decode remaining_precision
      If (remaining_precision >= pred_mv_precision)
        pb_mv_precision = remaining_precision + 1
      else
        pb_mv_precision = remaining_precision
} else
      pb_mv_precision = pred_mv_precision
```

In an example, and as mentioned, a DPL of MV precisions may be created (e.g., constructed) from the MV precisions of neighboring blocks of the current block. The neighboring blocks that are used to obtain the DPL can include the blocks in zero or more rows above the current block, blocks in zero or more columns to the left of the current block, or a combination thereof. The DPL includes the list of MV precisions supported for the current prediction block. That is, the MV precisions that are included in the DPL are limited by any maximum MV precision and/or minimum MV precision of the MV precision of the current block. In the DPL, the most probable MV precision can be placed at index 0 and the least probable MV precision can be placed at the largest index.

The MV precisions can be ordered (from most probable to least probable) according to the number of times that the MV precision is used by the neighboring blocks; and in the case of ties, the MV precisions can be ordered based on distances of the neighboring block to the current block. A distance between the current block and a neighboring block can be measured as the distance between co-located pixels (e.g., top-left pixels) of the blocks.

The compressed bitstream can include the index, in the DPL, of the MV precision that is to be used for pb_mv_precision. To illustrate, and without loss of generality, the DPL may include, in this order, MV_PRECISION_1_PEL, MV_PRECISION_EIGHTH_PEL, MV_PRECISION_4_PEL, and MV_PRECISION_QTR_PEL. The compressed bitstream may include an index=1 into the DPL. As such, the MV precision, pb_mv_precision, of the current block can be set to MV_PRECISION_EIGHTH_PEL.

In an example, the DPL includes all of the allowed precisions of a block. If some allowed MV precisions are not found from the neighboring blocks, those precisions may be placed at the end of the DPL list. In another example, if the DPL does not include the MV precision of the block, a difference between the most probable MV precision and the actual MV precision (i.e., pb_mv_precision) may be encoded in the compressed bitstream.

In an example, the generation of the DPL may also depend on at least one of the block size, prediction modes, motion models, or a motion vector candidate list. For example, if a neighboring block has a size that is not within a size threshold of the current block, then the MV precision of the block may not added to the DPL list. For example, if the motion vector of a neighboring block is not a candidate motion vector for the current block, then the MV precision of the current block may not be added to the DPL list.

In an example, and as mentioned above, the MV precision of the current block may be inferred based on the size of the block. For example, if the block is determined to be a small block (e.g., 4×4 or 8×8), then pb_mv_precision can be assumed to be MV_PRECISION_EIGHTH_PEL and pb_mv_precision need not be decoded from (or encoded in) the compressed bitstream.

In an example, the MV precision of the current block may be inferred based on the prediction mode of the block. To illustrate, the codec may support several motion modes. A motion mode (i.e., an inter-prediction mode) indicates the type of motion compensation that is to be performed to obtain a prediction block for the current block. The inter-prediction mode of the current block may be decoded from the compressed bitstream. For example, the AV1 codec supports three motion modes (signaled using the syntax element motion_mode): Overlapped Block Motion Compensation (OBMC), a local warping model (LOCALWARP), and a simple translation model (SIMPLE). If the motion mode of the current block is not the simple translation model (SIMPLE), then the MV precision is not decoded and is inferred to be the maximum precision value (e.g., MV_PRECISION_EIGHTH_PEL). Translational motion is characterized as pixel shifts of a prediction block in a reference frame in the x- and y-axes as compared to the block being predicted.

As mentioned, interpolation filters may be used to obtain sub-pixel values. Some codecs may encode the particular interpolation filter that the decoder is to use to calculate the sub-pixel values. For example, the encoder may encode (and the decoder may decode) a syntax element that indicates the interpolation filter that is to be used for the current block. The syntax element may be an index of the interpolation filter amongst available interpolation filters.

In some examples, if the MV precision pb_mv_precision of the current block is less than a predefined MV precision threshold (e.g., MV_PRECISION_1_PEL), then the interpolation filter is not signaled for that predicted block and, instead, can be inferred to be a filter that is designated as a default filter. A default filter is an interpolation filter that the encoder and decoder are configured to use as a default from amongst available interpolation filters. Each of the available interpolation filters can have a different cutoff frequency and may be designed to deal with various types of noise and/or distortions that can occur in reference frames or blocks.

In another example, if the MV precision of the current block does not have a sub-pixel accuracy, then an interpolation filter is not signaled. That is, the compressed bitstream would not include syntax elements indicating an interpolation filter in the case that the MV precision cannot be one that indicates sub-pixel accuracy. For example, if the MV precision is one of MV_PRECISION_4_PEL, MV_PRECISION_2_PEL, or MV_PRECISION_O_PEL, then an interpolation filter is not signaled. As already mentioned, the MV precision can be a block-level MV precision, or a group-of-blocks MV precision. That is, if the pb_mv_precision is decoded to be an integer MV precision or inferred to be an integer MV precision, then the compressed bitstream would not include an indication of an interpolation filter for the current block.

In an example, specific interpolation filters may be associated with respective MV precisions. To illustrate, and without loss of generality, the MV precision MV_PRECISION_EIGHTH_PEL may be associated with an interpolation filter named EIGHTTAP_SMOOTH. As such, if MV_PRECISION_EIGHTH_PEL is decoded as the pb_mv_precision for the current block, then the EIGHTTAP_SMOOTH filter will be used.

In another example, more than one interpolation filter may be associated with an MV precision value. For example, assume that MV_PRECISION_QTR_PEL is associated with the interpolation filters named EIGHTTAP_SMOOTH and EIGHTTAP_SHARP. Assume further that four interpolation filters are available and ordered such that EIGHTTAP_SMOOTH and EIGHTTAP_SHARP are associated with the orders 2 and 3, respectively. Thus, 2 bits would be required to code a particular interpolation filter. However, if MV_PRECISION_QTR_PEL is determined to be the value of pb_mv_precision, then only one bit would be required (instead of two) to indicate whether the interpolation filter to use is the EIGHTTAP_SMOOTH filter or the EIGHTTAP_SHARP filter.

Returning again to FIG. 9, at 906, an MV for the current block is decoded using the block-level MV precision. As mentioned above, decoding a MV can mean or include decoding a MVD, which can be added to a predicted MV (PMV). Decoding the MV is further described below. At 908, a prediction block is obtained for the current block using the MV. The prediction block can be obtained as described with respect to the intra/inter prediction stage 508 of FIG. 5.

For simplicity, the description herein may refer to coding of a motion vector. However, coding a motion vector includes separately coding the horizontal offset (i.e., MVx) and the vertical offset (i.e., MVy) of the motion vector. As mentioned, instead of signaling the motion vector itself, an MVD value may be signaled in the bitstream. In some codec, the integer pel portion of the MVD may be signaled first followed by a fractional (sub-pel) portion of the MVD.

The integer pel portion of MVD may be divided into a predefined number of classes (MV classes). For each prediction block, the MV class may be signaled first followed by one or more bits (starting from the LSB to the most significant bit (MSB)) that specify the integer part of the offset that is the difference between the MVD and the starting magnitude of MV class of the MVD. The number of bits required to code the offset depends on the class and the number of MVDs that the class represents.

Stated another way, to reduce the number of bits required to code an MVD, the magnitude of the MVD may be partitioned into classes where each class includes a number of MVDs. The encoder may classify an MVD into a selected MV class from amongst available MV classes. In another example, each of the horizontal offset and the vertical offset may be separately classified into respective MV classes. An MV class may be selected based on the magnitude of the MVD. Selecting an MV class can include selecting an MV class for the class horizontal offset and separately selecting an MV class for the vertical offset. Within each of available MV classes, a number of MVDs may be available. In an example, an MV class may be selected based on both of the horizontal offset and the vertical offset of the MVD. Thus, coding an MVD includes coding the MV class of the MVD and coding an offset within the class indicating the specific MVD within the class.

To illustrate, and without loss of generality, the available MV classes may include the classes labeled class0, class1, class2, class3, and so on corresponding to integer values 0, 1, 2, 3, and so on. Any number of classes may be available. In an example, 11 classes are available. A class i of these MV classes may include (or represent) a number (num_mvdsᵢ) of MVDs given by 2ⁱ⁺¹ MVDs. A base MVD (base_mvdᵢ) of an MV class i (e.g., a very first MVD represented by the MV class) may the MVD that follows the last MVD (last_mvd) represented by the MV class i−1; and the last MVD (last_mvdᵢ) of an MV class i may be given by the base MVD (base_mvdᵢ) plus the number of MVDs represented by the class. As such, and to illustrate, for class3 (i.e., i=3), the number of MVDs represented by the class is 16; the very first MVD (i.e., base_mvd) is 14; and the last MVD represented by the class is 29. That is, class3 represents the MVDs 14 to 29. These relationships may be symbolically given by:

$${num\_mvds}_{i} = {2}^{i + 1} \\ {base\_mvd}_{i} = {last\_mvd}_{i - 1} + 1 , where {base\_mvd}_{0} = 0 and {last\_mvd}_{0} = 1 \\ {last\_mvd}_{i} = {base\_mvd}_{i} + {num\_mvds}_{i}$$

Conventionally, coding an MVD includes coding the MVD class (i.e., the MV class) and coding an offset that indicates the particular MVD within the class. To illustrate, assume that an MVD is given by the class MV class3 (described above) and the offset 7 within the class. Thus, to code the MVD, the bits 11 (indicating MV class=3) and bits 0111 (indicating offset 7) would be used. It is noted that 4 bits are used to code the offset since the maximum offset number that may need to be coded for the class is 16.

Using the signaled (i.e., encoded) or inferred MVD precision of the current block, the respective number of bits required to code the integer portion and/or the fractional portion of the MVD may be reduced.

FIG. 12 is an example of a flowchart of a technique 1200 for decoding a motion vector of a current block. The technique 1200 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1200. The technique 1200 may be implemented in whole or in part in the entropy decoding stage 502 or the intra/inter prediction stage 508 of the decoder 500 of FIG. 5. The technique 1200 can be implemented using specialized hardware or firmware. Multiple processors, memories, or both, may be used.

The technique 1200 can be performed when decoding a current block that is inter-predicted. The technique 1200 can be performed to obtain a component of the motion vector of the current block. As such, the technique 1200 can be performed a first time to obtain the horizontal component of the motion vectors and performed a second time to obtain the vertical component of the motion vector.

The technique 1200 can be performed to obtain a prediction block using a motion vector that is decoded (i.e., using data decoded) from a compressed bitstream, such as the compressed bitstream 420 of FIG. 5. The motion vector is coded differentially.

At 1202, an MV class of an MVD for the current block is decoded from the compressed bitstream. As described above, the MV class can be indicative of or includes a set of MVDs; and the MVD can include at least one of an integer portion or a fractional portion. At 1204, an MV precision of the MVD is obtained. The MV precision can be obtained as described above. The MV precision can be as described above with respect to pb_mv_precision. In an example, and as described above, the MV precision can be decoded from the compressed bitstream. In an example, and as also described above, the MV precision can be inferred.

At 1206, at least a subset of bits indicative of the integer portion of the MVD is decoded from the compressed bitstream using the MV precision and the MV class. More specifically, the bits indicative of the integer portion are the bits indicating the offset that is the difference between the integer portion of the MVD and the starting magnitude of MV class of the MVD. Whereas a total of N bits may be used to represent the integer portion of the MVD, M bits (M≤N) may be decoded and the remaining N−M bits are inferred to be 0. Table IV illustrates a pseudocode for decoding at least a subset of bits representing an integer portion of the MVD using the MV precision and the MV class.

TABLE IV

| | |
|---|---|
| 1 | offset = 0 |
| 2 | Derive start_lsb as follows: |
| 3 | start_lsb = 0 |
| 4 | If (pred_mv_precision == MV_PRECISION_4_PEL) |
| | then start_lsb = 2 |
| 5 | If (pred_mv_precision == MV_PRECISION_2_PEL) |
| | then start_lsb = 1 |
| 6 | for (int i=start_lsb; i < MV class; ++i ) { |
| 7 | decode mv_bit from compressed bitstream |
| 8 | offset = offset \| (mv_bit << i) |
| 9 | } |

At line 1, offset is initialized to zero. Lines 3-5 of Table IV determine the number of bits of the offset that can be inferred. The variable start_lsb indicates the number of LSB bits of the integer portion that can be inferred. If the MV precision is MV_PRECISION_4_PEL, then the two least significant bits can be inferred to be zero and decoding of the bits of the offset can start after those two bits. As such, responsive to determining that the MV precision indicates a 4-integer pixel magnitude, the two least significant bits of the bits representing the integer portion can be inferred to be zero.

If the MV precision is MV_PRECISION_2_PEL, then the least significant bit can be inferred to be zero and decoding of the bits of the offset can start after that bit. As such, responsive to determining that the MV precision indicates a 2-integer pixel magnitude, one least significant bit (i.e., the least significant bit) of the bits representing the integer portion can be inferred to be zero.

The loop in lines 6-9 decodes from the bitstream a number of bits that is equal to the number of bits corresponding to the MV class minus the number of inferred bits. After each bit is decoded, it is added to the bits representing the offset by right-shifting the mv_bit by the loop index i, which corresponds to the current bit position of offset, and or-ing the right-shifted bit with the current value of offset. As such, at least a subset of bits representing a fractional portion of the MVD can be decoded using the MV precision.

At 1208, the MVD is obtained using the bits representing the integer portion of the MVD. For example, sign data (described below), the integer potion, and fractional (i.e., sub-pel) portion data (described below), if any, may be combined to obtain the MVD itself. At 1210, the motion vector for the current block is obtained using the MVD. As described above, the MVD can be added to a PMV to obtain the motion vector. At 1212, a prediction block for the current block can be obtained using the motion vector. The prediction block can be obtained as described with respect to the intra/inter prediction stage 508 of FIG. 5.

In an example, the technique 1200 can also include decoding whether the value of the MVD is zero or not. If the value of the MVD is not zero, then the technique 1200 can decode sign data of the MVD and proceeds to performing the steps 1202-1208. If the value of the MVD is zero, then the technique 1200 does not perform the steps 1202-1208.

In an example, the MV precision may indicate that the MVD includes a fractional component; and the technique 1200 can further include decoding, using the MV precision, at least a subset of bits representing a fractional portion of the MVD. For example, the codec may be designed to represent the fractional component of an MVD using a number of bits (e.g., 3 bits). The bits indicate the sub-pixels precision of the MVD. The MV precision can be used to infer at least some of the fractional bits. As such, fewer bits indicative of the fractional component need be included in the compressed bitstream based on the MV precision, pb_mv_precision. Table V illustrates a pseudocode for the decoding bits indicating the fractional bits (fr_bits) of the MVD.

TABLE V

1 fr_bits = 0
2 if (pb_mv_precision > MV_PRECISION_1_PEL)
3 fr_bits |= ((decode fr_bit) << 2)
4 if (pb_mv_precision > MV_PRECISION_HALF_PEL)
5 fr_bits |= ((decode fr_bit) << 1)
6 if (pb_mv_precision > MV_PRECISION_QTR_PEL)
7 fr_bits |= (decode fr_bit)

At line 1, the fractional bits are initialized to 0. At lines 2-3, if the MV precision is greater than MV_PRECISION_1_PEL, fr_bits is updated to the value that results from or'ing the current value of fr_bits with one bit decoded from the compressed bitstream (fr_bit) and left-shifted by 2 positions. At lines 4-5, if the MV precision is greater than MV_PRECISION_HALF_PEL, fr_bits is updated to the value that results from or'ing the current value of fr_bits with one bit decoded from the compressed bitstream (fr_bit) and left-shifted by 1 position. At lines 6-7, if the MV precision is greater than MV_PRECISION_QTR_PEL, fr_bits is updated to the value that results from or'ing the current value of fr_bits with one bit decoded from the compressed bitstream (fr_bit). While not explicitly shown in Table V, if the pb_mv_precision is less than or equal MV_PRECISION_1_PEL, then no bits are decoded from the compressed bitstream for the fractional portion of the MVD and the fractional portion is set to 0 (i.e., fr_bits=0, at line 1).

As such, responsive to determining that the MV precision indicates a precision that is not finer than a ¼ pixel precision, the least significant bit of the bits representing the fractional portion can be inferred to be zero. Similarly, responsive to determining that the MV precision indicates a precision that is not finer than a ½ pixel precision, then the two least significant bits of the bits representing the fractional portion can be inferred to be zero. Additionally, responsive to determining that the MV precision indicates an integer pixel precision, all the bits representing the fractional portion can be inferred to be zero.

As mentioned above, the motion vector of a current block can be encoded differentially with respect to a predicted motion vector. This may be referred to as predictive coding for motion vectors. The predicted motion vector (i.e., PMV) may be selected from a candidate motion vector list (i.e., a list of candidate motion vectors), ref_mv_stack[ ]. The encoder and the decoder of a codec may use the same rules or heuristics for constructing the motion vector candidate list ref_mv_stack[ ] for a current block. The encoder encodes the index ref_mv_idx, in the list, of the motion vector candidate that is the PMV; and the decoder decodes the index to obtain the PMV from the list (i.e., ref_mv_stack[ref_mv_idx]). As mentioned, the decoder also decodes the MVD and obtains the motion vector for the block using MV=MVD+ref_mv_stack[ref_mv_idx]. Several techniques are known for obtaining a motion vector candidate list from spatial and temporal neighbors of the current block and the disclosure herein is not limited by any particular way of obtaining such list.

At least some of the candidate motion vectors of ref_mv_stack may have MV precisions that are inconsistent with the MV precision pb_mv_precision of the current block. That is, the MV precisions of such blocks may be higher (i.e., greater) or lower (i.e., smaller) than pb_mv_precision of the motion vector of the current block. In some implementations according to this disclosure, the MV precisions of such candidate motion vectors can be converted to the MV precision pb_mv_precision of the prediction block.

To illustrate, and without loss of generality, assume that pb_mv_precision is MV_PRECISION_4_PEL but that one of the candidate motion vectors has an MV precision of MV_PRECISION_QTR_PEL. As such, the MV precision of this candidate motion vector is rounded up to be MV_PRECISION_4_PEL. As such, respective MV precisions may be maintained (e.g., stored in a memory) in association with the candidate motion vectors so that these maintained MV precisions can be converted to match the MV precision pb_mv_precision of the current block. That is, respective precisions of at least some of the candidate MVs are set (e.g., rounded up or down) to the MV precision pb_mv_precision of the current block. The at least some of the candidate MVs whose MV precisions are set (e.g., converted) are those that are inconsistent with the MV precision pb_mv_precision of the current block.

Alternatively, or additionally, converting an MV precision of a motion vector can include altering the motion vector itself (or a copy thereof). To illustrate, and without loss of generality, as discussed above, the 3 LSBs of a motion vector can be used to indicate the fractional precision of the motion vector. If pb_mv_precision is MV_PRECISION_1_PEL, then the 3 LSBs of the candidate motion vector (or its copy) can be set to 0. More generally, the bits of a candidate motion vector that indicate a precision (i.e., magnitude and/or fractional precision) that is greater than pb_mv_precision can be set to 0.

The description above, mainly describes operations of a decoder. However, and as can be appreciated, parallel operations can be performed by an encoder. For example, whereas the decoder decodes syntax elements from a compressed bitstream, the encoder encodes (or signals) such syntax elements in the compressed bitstream; and whereas the decoder omits decoding certain syntax elements, the encoder omits encoding (i.e., does not include or does not signal) such syntax elements in the compressed bitstream. Coding (e.g., encoding or decoding) a syntax element means coding a value for the syntax element.

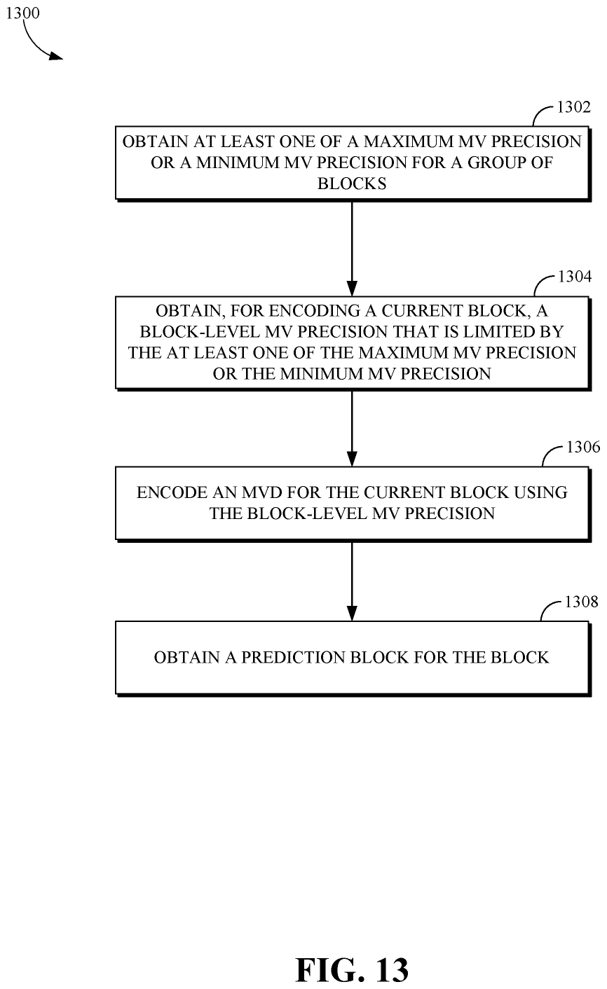

As such, FIG. 13 is an example of a flowchart of a technique 1300 for encoding a motion vector of a current block. The technique 1300 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1300. The technique 1300 may be implemented in whole or in part in the intra/inter prediction stage 408 of the encoder 400 of FIG. 4. The technique 1300 can be implemented using specialized hardware or firmware. Multiple processors, memories, or both, may be used.

At 1302, at least one of a maximum MV precision or a minimum MV precision for a group of blocks is obtained. At 1304, a block-level MV precision that is limited by the at least one of the maximum MV precision or the minimum MV precision is obtained for encoding the current block. For example, the encoder may select the at least one of a maximum MV precision or a minimum MV precision and the block-level MV precision based on the content of the group of block and the current block being encoded. For example, the encoder may evaluate rate-distortion information, bit budgets, or other factors. However, the teachings herein are not limited in any way by any technique used by the encoder to select the maximum MV precision for a group of blocks, the minimum MV precision for the group of blocks, or the block-level MV precision.

While not specifically shown in FIG. 13, the encoder may encode zero or more of the maximum MV precision, the minimum MV precision, or the block-level MV precision. As mentioned above, in some cases, some of the maximum MV precision, the minimum MV precision, or the block-level MV precision may be inferred by the decoder. As such, the encoder need not encode them in the compressed bitstream. In an example, the encoder may encode an MV of a group of blocks based on the MV precisions of the blocks of the group of blocks. For example, the encoder may perform a first pass of encoding (e.g., predicting without writing to the compressed bitstream) all the blocks of the group of blocks. The encoder can use the first pass encoding data (e.g., results, statistics, etc.) to obtain the group-of-blocks level MV precision.

At 1306, an MVD for the current block is encoded using the block-level MV precision. Encoding the MV parallels the decoding of an MV described with respect to FIG. 9. At 1308, a prediction block for the block is obtained. The prediction block can be used to obtain a residual block that can be encoded in the compressed bitstream, as described with respect to FIG. 4.

With respect to Table IV, the encoder can perform parallel operations to encode bits corresponding to the offset of the MVD in the compressed, as illustrated in Table VI.

TABLE VI

| | |
|---|---|
| 1 | Determine value of offset |
| 2 | Derive start_lsb |
| 3 | start_lsb = 0 |
| 4 | If (pred_mv_precision == MV_PRECISION_4_PEL) |
| | then start_lsb = 2 |
| 5 | If (pred_mv_precision == MV_PRECISION_2_PEL) |
| | then start_lsb = 1 |
| 6 | for (int i=start_lsb; i < MV class; ++i ) |
| 7 | encode (offset >> i) & 1 |

With respect to Table V, the encoder can also perform parallel operations to encode bits corresponding to the fractional component of an MVD based on the MV precision, as illustrated in Table VII. Given an MVD calculated (e.g., determined, selected, etc.) by the encoder, where the 3 LSBs of the MVD indicate the fractional precision, the pseudocode of Table VII illustrates the skipping of encoding of bits that can be inferred based on the MV precision of the current block (i.e., the MV precision of the motion vector or MVD of the current block).

TABLE VII

| | |
|---|---|
| 1 | if (pb_mv_precision > MV_PRECISION_1_PEL) |
| 2 | encode (MVD >> 2) & 1 |
| 3 | if (pb_mv_precision > MV_PRECISION_HALF_PEL) |
| 4 | encode (MVD >> 1) & 1 |
| 5 | if (pb_mv_precision > MV_PRECISION_QTR_PEL) |
| 6 | encode (MVD & 1) |

At lines 1-2, if the MV precision of the current block (i.e., of the MVD of the current block) is greater than MV_PRECISION_1_PEL, then the third LSB, which indicates whether the MVD precision is ½ precision, is encoded in the bitstream. At lines 3-4, if the MV precision of the MVD precision of the MVD of the current block is greater than MV_PRECISION_HALF_PEL, then the second LSB, which indicates whether the MVD precision is ¼ precision, is encoded in the bitstream. At lines 5-6, if the MV precision of the current block is greater than MV_PRECISION_QTR_PEL, then the LSB, which indicates whether the MVD precision is ⅛ precision, is encoded in the bitstream. While not explicitly shown in Table VII, if the pb_mv_precision is less than or equal MV_PRECISION_1_PEL, then no bits are encoded in the compressed bitstream for the fractional portion of the MVD.

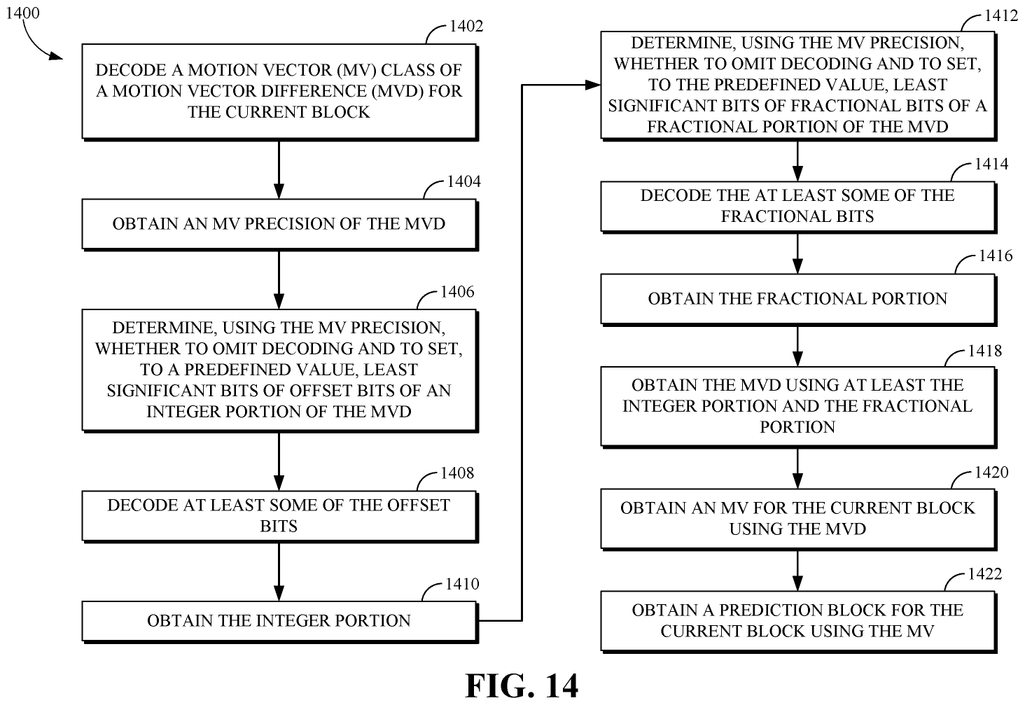

FIG. 14 is another example of a flowchart of a technique 1400 for decoding a motion vector for a current block. The technique 1400 decodes an MVD that is used to obtain the MV for the current block. The MVD includes an integer portion and a fractional portion. The technique 1400 obtains the integer portion and the fractional portion of the MVD.

The technique 1400 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1400. The technique 1400 may be implemented in whole or in part in the intra/inter prediction stage 508 of the decoder 500 of FIG. 5. The technique 1400 can be implemented using specialized hardware or firmware. Multiple processors, memories, or both, may be used.

At 1402, an MV class of the MVD is decoded from a compressed bitstream, which can be the compressed bitstream 420 of FIG. 5. As described above, the MV class is indicative of a set of MVDs where each MVD of the set of MVDs corresponds to respective integer portions. At 1404, an MV precision of the MVD is obtained. The MV precision can be obtained as described above. For example, the MV precision can be obtained as described with respect to 1204 of FIG. 12.

At 1406, the technique 1400 determines, using the MV precision, whether to omit decoding and to set, to a predefined value, least significant bits of offset bits of the integer portion. In an example, determining, using the MV precision, whether to omit decoding and to set, to a predefined value, the least significant bits of offset bits of the integer portion can be as described with respect to the pseudo-code of Table IV, such as consistent with the lines 3-5. As such, the least significant bits of the offset bits of the integer portion can be or constitute 2 bits in a case that the MV precision indicates a 4-integer pixel magnitude; and the least significant bits of the offset bits of the integer portion can be or constitute 1 bit in a case that the MV precision indicates a 2-integer pixel magnitude.

At 1408, at least some of the offset bits are decoded from the compressed bitstream. The at least some of the offset bits can be decoded consistent with lines 6-9 of Table IV. At 1410, the integer portion can be obtained using the at least some of the offset bits and the least significant bits of the integer portion. The integer portion can be obtained consistent with lines 6-9 of Table IV. When the loop of lines 6-9 completes, the integer portion will be obtained. As such, the least significant bits of the offset bits of the integer portion can be or constitute 2 bits in a case that the MV precision indicates a 4-integer pixel magnitude; and the least significant bits of the fractional portion can be or constitute the least significant bit in case that the MV precision indicates a precision that is not finer than a ¼ pixel precision.

At 1412, the technique 1400 determines, using the MV precision, whether to omit decoding and to set, to the predefined value, least significant bits of fractional bits of the fractional portion. In an example, determining, using the MV precision, whether to omit decoding and to set, to the predefined value, least significant bits of fractional bits of the fractional portion can be as described with respect to the pseudo-code of Table V. Setting the least significant bits of fractional bits to zero is accomplished by setting fr_bits to zero at line 1 of Table V.

At 1414, the at least some of the fractional bits for the fractional portion are decoded from the compressed bitstream, such as described with respect to one or more of lines 3, 5, or 7 of Table V. Which of the lines are executed depends on the MV precision, as already described. At 11416, the fractional portion is obtained using the at least some of the fractional bits and the least significant bits of the fractional portion. That is, when the pseudocode of Table V completes, the fractional portion will be obtained.

At 1418, the MVD is obtained using at least the integer portion and the fractional portion. The integer portion and the fractional portion can be combined to obtain the MVD using MVD=(2<< ((MV class)+1))+ ((offset<<3)| fr_bits). In an example, a sign (mv_sign) of the MVD may also be decoded from the compressed bitstream. The sign, mv_sign, may be flag that indicates whether the MVD is positive (e.g., mv_sign=0) or negative (e.g., mv_sign=1). Thus, a final value of the MVD can be obtained as using: (mv_sign?-MVD: MVD).

At 1420, the MV of the current block is obtained using the MVD. Obtaining the MV can include obtaining a PMV and obtaining the MV as MV=PMV+MVD. At 1422, a prediction block is obtained for the current block using the motion vector. The prediction block can be obtained as described with respect to intra/inter prediction stage 508 of FIG. 5.

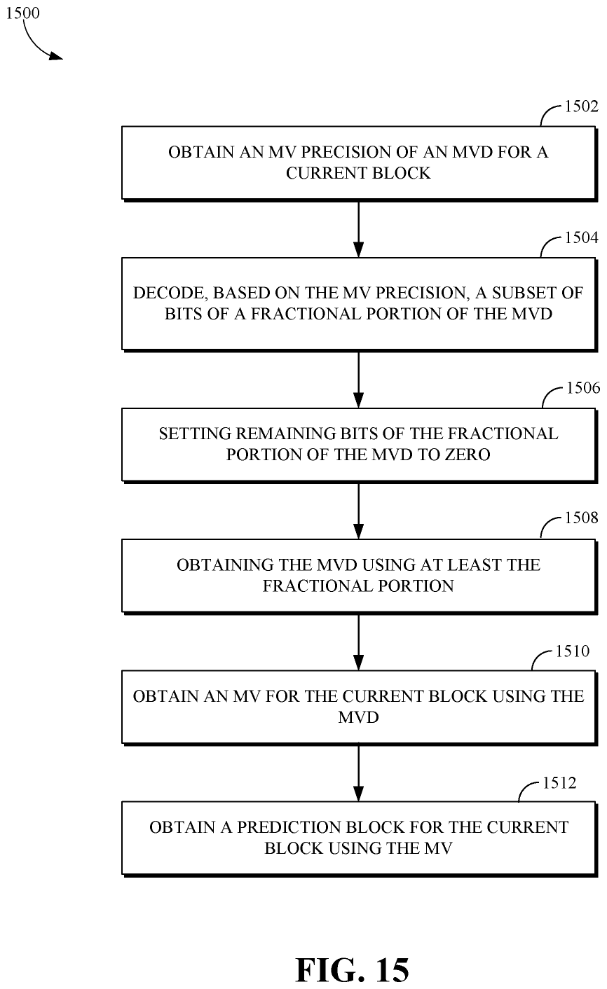

FIG. 15 is another example of a flowchart of a technique 1500 for decoding a motion vector for a current block. The technique 1500 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1500. The technique 1500 may be implemented in whole or in part in the intra/inter prediction stage 508 of the decoder 500 of FIG. 5. The technique 1500 can be implemented using specialized hardware or firmware. Multiple processors, memories, or both, may be used.

At 1502, an MV precision of an MVD of a current block is obtained. The MV precision can be obtained as described above. At 1504, a subset of bits of a fractional portion of the MVD is decoded from a compressed bitstream based on the MV precision, as described above. That is, the MV precision can be used to determine (e.g., select, identify, etc.) the subset of the bits to decode. Equivalently, the MV precision may be used to determine the remaining bits of the fractional bits that are to be set to zero. At 1506, the remaining bits of the fractional portion of the MVD are set to zero.

At 1508, the MVD is obtained using at least the fractional portion, as described above. At 1510, a motion vector for the current block is obtained using the MVD, such as described above. At 1512, a prediction block is obtained for the current block using the motion vector, as described above.

In an example, the technique 1500 can include obtaining candidate MVs for the MV. An MV precision of a candidate MV of the candidate MVs can be converted to match the MV precision, as described above. In an example, the technique 1500 can include decoding, from the compressed bitstream, an MV class of the MVD, as described above. The MV class can be indicative of a set of MVDs. Each MVD of the set of MVDs corresponds to respective integer portions. An integer portion of the MVD can be decoded from the compressed bitstream.

For simplicity of explanation, the techniques described herein, such as the techniques 900, 1200, 1300, 1400, and 1500 of FIGS. 9, 12, 13, 14, and 15, respectively, are depicted and described as series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. An apparatus for decoding a current block, comprising:
a processor configured to:
decode, from a compressed bitstream, a motion vector (MV) class of a motion vector difference (MVD) for the current block,
wherein the MV class is indicative of a set of MVDs, each MVD of the set of MVDs corresponds to respective integer portions, and
wherein the MVD comprises an integer portion and a fractional portion;
obtaining an MV precision of the MVD;
determine, using the MV precision, whether to omit decoding least significant bits of offset bits of the integer portion and to set the least significant bits of offset bits of the integer portion to a predefined value;
decoding decode at least some of the offset bits;
obtaining obtain the integer portion using the at least some of the offset bits and the least significant bits of the integer portion;
determine, using the MV precision, whether to omit decoding and to set, to the predefined value, least significant bits of fractional bits of the fractional portion;
decode the at least some of the fractional bits for the fractional portion;
obtain the fractional portion using the at least some of the fractional bits and the least significant bits of the fractional portion;
obtain the MVD using at least the integer portion and the fractional portion;
obtain a motion vector for the current block using the MVD; and
obtain a prediction block for the current block using the motion vector.

2. The apparatus of claim 1, wherein the least significant bits of the offset bits of the integer portion constitute 2 bits in a case that the MV precision indicates a 4-integer pixel magnitude.

3. The apparatus of claim 1, wherein the least significant bits of the offset bits of the integer portion constitute 1 bit in a case that the MV precision indicates a 2-integer pixel magnitude.

4. The apparatus of claim 1, wherein the least significant bits of the fractional portion constitute the least significant bit in a case that the MV precision indicates a precision that is not finer than a ¼ pixel precision.

5. The apparatus of claim 1, wherein the least significant bits of the fractional portion constitute two least significant bits in a case that the MV precision indicates a precision that is not finer than a ½ pixel precision.

6. An apparatus for decoding a current block, comprising:
a processor configured to:
decode, from a compressed bitstream, a motion vector (MV) class of a motion vector difference (MVD) of the current block, wherein the MV class is indicative of a set of MVDs, and wherein the MVD includes an integer portion;
obtain an MV precision of the MVD;
decode, using the MV precision and the MV class, at least a subset of bits representing the integer portion of the MVD;
obtain the MVD using the bits representing the integer portion of the MVD;
obtain a motion vector for the current block using the MVD; and
obtain a prediction block for the current block using the motion vector.

7. The apparatus of claim 6, wherein to decode, using the MV precision and the MV class, the at least the subset of bits representing the integer portion of the MVD comprises to:
infer that at least one least significant bit of bits representing the integer portion of the MVD is zero based on the MV precision.

8. The apparatus of claim 6, wherein to decode, using the MV precision and the MV class, the at least the subset of bits representing the integer portion of the MVD comprises to:
responsive to determining that the MV precision indicates a 4-integer pixel magnitude, infer that two least significant bits of the bits representing the integer portion are zero.

9. The apparatus of claim 6, wherein to decode, using the MV precision and the MV class, the at least the subset of bits representing the integer portion of the MVD comprises to:
responsive to determining that the MV precision indicates a 2-integer pixel magnitude, infer that one least significant bit of the bits representing the integer portion are zero.

10. The apparatus of claim 6, wherein the processor is configured to:
decode, using the MV precision, at least a subset of bits representing a fractional portion of the MVD.

11. The apparatus of claim 10, wherein to decode, using the MV precision, the at least the subset of bits representing the fractional portion of the MVD comprises to:
responsive to determining that the MV precision indicates a precision that is not finer than a ¼ pixel precision, infer that a least significant bit of the bits representing the fractional portion is zero.

12. The apparatus of claim 10, wherein to decode, using the MV precision, the at least the subset of bits representing the fractional portion of the MVD comprises to:
responsive to determining that the MV precision indicates a precision that is not finer than a ½ pixel precision, infer that two least significant bits of the bits representing the fractional portion are zero.

13. The apparatus of claim 10, wherein to decode, using the MV precision, the at least the subset of bits representing the fractional portion of the MVD comprises to:
responsive to determining that the MV precision indicates an integer pixel precision, infer that the bits representing the fractional portion are zero.

14. The claim 6, wherein the processor is configured to:
obtain candidate MVs for the MV; and
set respective precisions of at least some of the candidate MVs to the MV precision.

15. An apparatus, comprising:
a processor configured to:
obtain a motion vector (MV) precision of a motion vector difference (MVD) of a current block;
decode, from a compressed bitstream and based on the MV precision, a subset of bits of a fractional portion of the MVD;
set remaining bits of the fractional portion of the MVD to zero;
obtaining the MVD using at least the fractional portion;
obtaining a motion vector for the current block using the MVD; and
obtaining a prediction block for the current block using the motion vector.

16. The apparatus of claim 15, wherein the processor is configured to:
decode, from the compressed bitstream, an MV class of the MVD, wherein the MV class is indicative of a set of MVDs, each MVD of the set of MVDs corresponds to respective integer portions; and
decode, from the compressed bitstream, an integer portion of the MVD.

17. The apparatus of claim 15, wherein the processor is configured to:
obtain candidate MVs for the MV; and
convert an MV precision of a candidate MV of the candidate MVs to match the MV precision.

18.-23. (canceled)
